(19) United States
(12) Patent Application Publication
(10) Pub. No.: US 2024/0078432 A1
(43) Pub. Date: Mar. 7, 2024

(54) SELF-TUNING MODEL COMPRESSION METHODOLOGY FOR RECONFIGURING DEEP NEURAL NETWORK AND ELECTRONIC DEVICE

(71) Applicant: Kneron Inc., San Diego, CA (US)

(72) Inventors: JIE WU, San Diego, CA (US); JUNJIE SU, San Diego, CA (US); BIKE XIE, San Diego, CA (US); Chun-Chen Liu, Taipei City (TW)

(73) Assignee: Kneron Inc., San Diego, CA (US)

(21) Appl. No.: 18/508,248

(22) Filed: Nov. 14, 2023

Related U.S. Application Data
(63) Continuation-in-part of application No. 16/001,923, filed on Jun. 6, 2018.

(51) Int. Cl. G06N 3/082; G06N 3/04

(52) U.S. Cl. CPC G06N 3/082; G06N 3/04

(57) ABSTRACT

A self-tuning model compression methodology for reconfiguring a Deep Neural Network (DNN) includes: receiving a pre-trained DNN model and a data set; performing an inter-layer sparsity analysis to generate a first sparsity result; and performing an intra-layer sparsity analysis to generate a second sparsity result, including: defining a plurality of sparsity metrics for the network; performing forward and backward passes to collect data corresponding to the sparsity metrics; using the collected data to calculate values for the defined sparsity metrics; and visualizing the calculated values using at least a histogram. The methodology further includes: according to the first and second sparsity results, performing low-rank approximation on the pre-trained DNN; pruning the represented DNN model according to the first and second sparsity results; performing quantization on the pruned DNN model according to the first and second sparsity results; and executing the reconfigured model on a user terminal for an end-user application.

### CROSS REFERENCE TO RELATED APPLICATIONS

This application is a continuation-in-part of U.S. application Ser. No. 16/001,923, filed on Jun. 6, 2018. The content of the application is incorporated herein by reference.

### BACKGROUND OF THE INVENTION

### 1. Field of the Invention

The present invention relates to a Deep Neural Network (DNN), and more particularly, to a method for reconfiguring a DNN model and an associated electronic device.

### 2. Description of the Prior Art

Large scale Deep Neural Networks have achieved remarkable results performing cutting-edge tasks in the fields of computer vision, image recognition, and speech recognition. Thanks to intensive computational power and a large amount of data and memory storage, deep earning models become bigger and deeper, enabling them to better learn from scratch. However, the high computation intensity of these models cannot be deployed at a resource-limited end-user with low memory storage and computing capabilities such as mobile phones and embedded devices. Moreover, learning from scratch is not feasible for end-users because of the limited data set. It means that end-users cannot develop customized deep learning models based on a very limited dataset.

### SUMMARY OF THE INVENTION

One of the objectives of the present invention is therefore to provide a self-tuning model compression methodology for reconfiguring a deep neural network, and an associated electronic device.

The self-tuning model compression methodology for reconfiguring a Deep Neural Network (DNN) comprises: receiving a pre-trained DNN model and a data set, wherein the pre-trained DNN model comprises an input layer, at least one hidden layer and an output layer, and said at least one hidden layer and the output layer of the pre-trained DNN model comprise a plurality of neurons; performing an inter-layer sparsity analysis of the pre-trained DNN model to generate a first sparsity result; and performing an intra-layer sparsity analysis of the pre-trained DNN model to generate a second sparsity result, which comprises: defining a plurality of sparsity metrics for the network; performing forward and backward passes to collect data corresponding to the sparsity metrics; using the collected data to calculate values for the defined sparsity metrics; and visualizing the calculated values using at least a histogram. The methodology further comprises: according to the first and second sparsity results, performing low-rank approximation on the pre-trained DNN to represent the pre-trained DNN model with low-rank counterparts; pruning the represented DNN model according to the first and second sparsity results; performing quantization on the pruned DNN model according to the first and second sparsity results to generate a reconfigured model of the DNN; and executing the reconfigured model on a user terminal for an end-user application.

The defined sparsity metrics comprise percentage of zeroes, small weight percentage, and L1 norms. The collected data comprises weight data obtained by extracting weights for all channels in the pre-trained DNN model, and activation data obtained by monitoring activations for each channel in the pre-trained DNN model after performing a forward pass. The weight data is used to calculate the percentage of zeroes and the percentage of small weights, and the activation data is used to calculate an average activation value or a percentage of activations below a certain threshold to compute an L1 norm for each channel.

The DNN model is used for computer vision targeted application models including an AlexNet, a VGG16, a ResNet, and a MobileNet, and natural language understanding application models. The end-user application is a visual recognition application or a speech recognition application.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a three-layer artificial neural network.

FIG. 2 is a flowchart illustrating a method for reconfiguring a DNN model according to an embodiment of the present invention.

FIG. 3 is a flowchart illustrating steps of compressing the DNN model into a reconfigured model according to an embodiment of the present invention. Expand/change to show different steps.

FIG. 4 is a diagram illustrating an electronic device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

The idea of artificial neural networks has existed for a long time; nevertheless, limited computational ability of hardware has been an obstacle to related research. Over the last decade, there has been significant progress in computational capabilities of processors and algorithms of machine learning. Only recently has an artificial neural network that can generate reliable judgments become possible. Gradually, artificial neural networks are being experimented with in many fields such as autonomous vehicles, image recognition, natural language understanding, and data mining.

Neurons are the basic computation units in a brain. Each neuron receives input signals from its dendrites and produces output signals along its single axon (usually provided to other neurons as input signals). The typical operation of an artificial neuron can be modeled as:

$$y = f ( {\sum }_{i} {w}_{i} {x}_{i} + b )$$

wherein x represents the input signal and y represents the output signal. Each dendrite multiplies its input signal x by a weight w; this parameter is used to simulate the strength of influence of one neuron on another. The symbol b represents a bias contributed by the artificial neuron itself. The symbol f represents a specific nonlinear function and is generally implemented as a sigmoid function, hyperbolic tangent function, or rectified linear function in practical computation.

For an artificial neural network, the relationship between its input data and final judgment is in effect defined by the weights and biases of all the artificial neurons in the network. In an artificial neural network adopting supervised learning, training samples are fed to the network. Then, the weights and biases of artificial neurons are adjusted with the goal of finding out a judgment policy where the judgments can match the training samples. During a forward pass of the network, input data is passed through the network and predictions are made. During a backward pass, the weights are adjusted to minimize a loss function. In an artificial neural network adopting unsupervised learning, whether a judgment matches the training sample is unknown. The network adjusts the weights and biases of artificial neurons and tries to find out an underlying rule. No matter which kind of learning is adopted, the goals are the same—finding out suitable parameters (i.e. weights and biases) for each neuron in the network. The determined parameters will be utilized in future computation.

Currently, most artificial neural networks are designed with a multi-layer structure. Layers serially connected between the input layer and the output layer are called hidden layers. The input layer receives external data and does not perform computation. In a hidden layer or the output layer, input signals are the output signals generated by its previous layer, and each artificial neuron included therein respectively performs computation according to the aforementioned equation. Each hidden layer and output layer can respectively be a convolutional layer or a fully-connected layer. The main difference between a convolutional layer and a fully-connected layer is that neurons in a fully connected layer have full connections to all neurons in its previous layer, whereas neurons in a convolutional layer are only connected to a local region of its previous layer. Many artificial neurons in a convolutional layer share parameters.

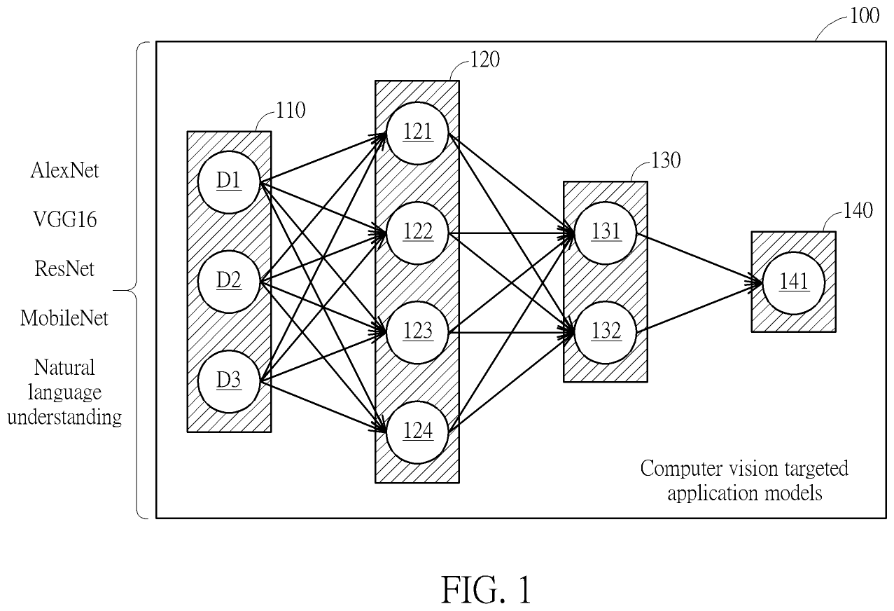

FIG. 1 is a diagram illustrating a three-layer artificial neural network as an example. It should be noted that, although actual artificial neural networks include many more artificial neurons and have more complicated interconnections than this example, those ordinarily skilled in the art will understand that the scope of the invention is not limited to a specific network complexity. Refer to FIG. 1. The input layer 110 is used for receiving external data D1˜D3. There are two hidden layers between the input layer 110 and the output layer 140. The hidden layers 120 and 130 are fully-connected layers. The hidden layer 120 includes four artificial neurons (121˜124) and the hidden layer 130 includes two artificial neuron (131˜132). The output layer 140 includes only one artificial neuron (141).

Currently, neural networks can have a variety of network structures. Each structure has its unique combination of convolutional layers and fully-connected layers. Taking the AlexNet structure proposed by Alex Krizhevsky et al. in 2012 as an example, the network includes 650,000 artificial neurons that form five convolutional layers and three fully-connected layers connected in series.

As the number of layers increases, an artificial neural network can simulate a more complicated function (i.e. a more complicated judgment policy). The number of artificial neurons required in the network will swell significantly, however, introducing a huge burden in the hardware cost. The high computational intensity of these models therefore cannot be deployed at a resource-limited end-user with low memory storage and computing capabilities, such as mobile phones and embedded devices. Besides, a network with this large scale is generally not an optimal solution for an end-user application. For example, the aforementioned AlexNet structure might be used for the recognition of hundreds of objects, but the end-user application might only be applying a network for the recognition of two objects. The pre-trained model with a large scale will not be the optimal solution for the end-user. The present invention provides a method for reconfiguring the DNN and an associated electronic device to solve the aforementioned problem.

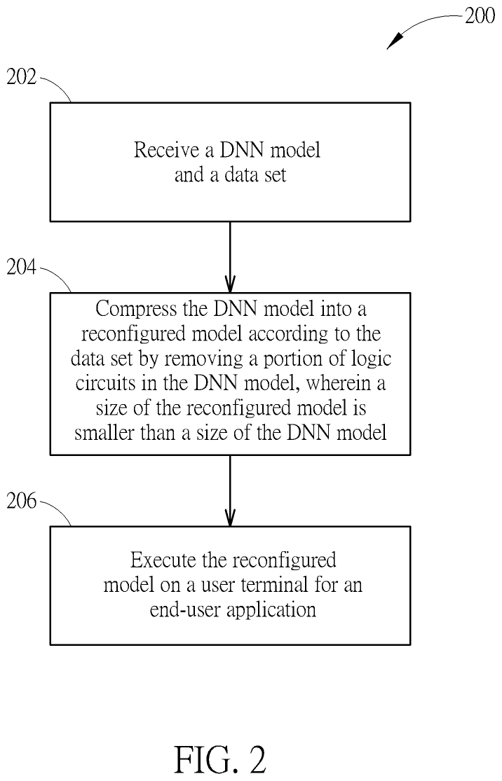

FIG. 2 is a flowchart illustrating a method 200 for reconfiguring a DNN model into a reconfigured model for an end-user terminal according to an embodiment of the present invention. The method is summarized in the following steps. Provided that the result is substantially the same, the steps are not required to be executed in the exact order as shown in FIG. 2.

Step 202: receive a DNN model and a dataset.

As mentioned above, the pre-trained model (for example, the AlexNet structure, VGG16, ResNet, or MobileNet structure) with the large scale is not applicable for the end-user terminal. In order to satisfy the end-user's requirements, inspired by the transfer-learning technique, the present invention applies the pre-trained model into the end-user terminal for an end-user application via the proposed self-tuning model compression technology. In this way, the pre-trained DNN model can learn customized features from the limited measurement dataset.

Step 204: compress the DNN model into a reconfigured model according to the data set by removing a portion of logic circuits in the DNN model, wherein a size of the reconfigured model is smaller than a size of the DNN model.

In this step, the DNN model is compressed into the reconfigured model which is applicable for the end-user terminal according to the provided dataset. As mentioned above, the DNN model comprises an input layer, at least one hidden layer and an output layer, wherein a neuron is the basic computation unit in each layer. In one embodiment, the compression operation removes a plurality of neurons from. the DNN model to form the reconfigured model, so that the number of neurons comprised in the reconfigured model is less than the number of neurons comprised in the pre-trained DNN model. As mentioned above, the typical operation of an artificial neuron can be modeled as:

$$y = f ( {\sum }_{i} {w}_{i} {x}_{i} + b )$$

To implement the above model, each neuron may be implemented by a logic circuit which comprises at least one multiplexer or at least one adder. The compression operation is dedicated to simplify the models of the neurons comprised in the pre-trained model. For example, the compression operation may remove at least one logic circuit from the pre-trained model to simplify the complexity of hardware to form the reconfigured model. In other words, the total number of logic circuits in the reconfigured model is less than in the pre-trained DNN model.

Step 206: execute the reconfigured model on a user terminal for an end-user application.

The present invention performs compression using a three-step method. In the first step, sparsity analysis is performed to generate data according to a number of defined sparsity metrics. Sparsity is an indication of the presence of zeroes within a network. Each node can be considered a filter which takes in data from nodes of a previous layer and outputs a pattern in the form of a weight, which is a decimal number between 0 and 1, wherein the higher the decimal, the more a computer considers the pattern to exist. Parameter values indicate how high the decimal needs to be for it to pass to a next layer.

The sparsity analysis indicates by how much the network can be compressed. Pruning is a compression method which removes lower ranked neurons or those which do not contribute a lot to the network. Pruning can therefore increase the speed of operation as well as reducing the size of the network to achieve compression. The disadvantage of related art pruning methods, however, is that they require training a dense network beforehand, and then performing repeated iterations so that a large amount of computation is required. Therefore, rather than performing pruning as the first step in the compression, a sparsity analysis is first carried out.

The sparsity analysis uses various metrics to analyze a number of zeroes within the DNN model. The invention sets a tolerance level which indicates how much information can be lost for each layer, as well as within the whole network. This means that, when pruning is performed subsequently, the pruning can occur in a single step and repeated iterations required by related art methods are not necessary.

In addition, before pruning is performed, a low-rank approximation of the network is carried out using weight metrics determined according to the sparsity analysis. This low-rank approximation (LRA) approximates weight matrices of the DNN model with low-rank counterparts to simplify the internal representation of the network. This reduces the effective number of parameters in the network without actually removing any channels or layers. The low-rank approximation uses the sparsity analysis as a means for determining by how much the network can be compressed, which helps further reduce the amount of computation required by the pruning operation.

Finally, pruning and quantization is carried out on the low-rank approximation of the DNN model, again according to the sparsity analysis.

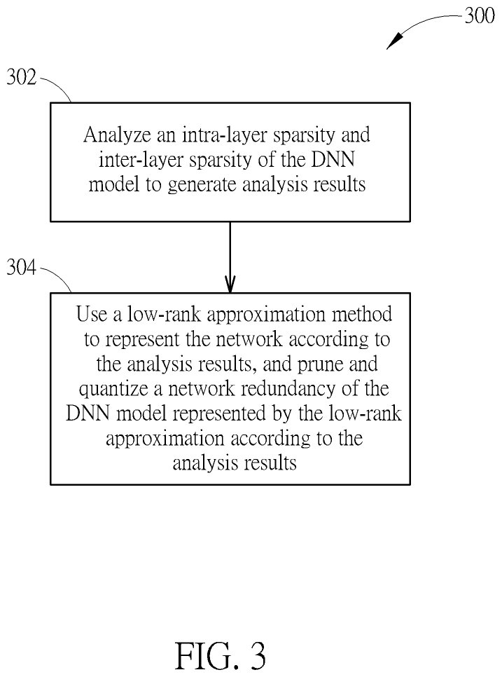

FIG. 3 is a flowchart 300 illustrating steps of compressing the DNN model into a reconfigured model according to an embodiment of the present invention. Provided that the result is substantially the same, the steps are not required to be executed in the exact order shown in FIG. 3.

Step 302: analyze an intra-layer sparsity and inter-layer sparsity of the DNN model to generate analysis results.

This step comprises analyzing weights and activations within a network by performing forward and backward passes, wherein weights are extracted for each channel, and activations are measured by computing average activation value or percentage of activations below a particular threshold. Both inter-layer and intra-layer sparsity analysis is performed. As is well-known in the art, image data inputted into a layer is called an input channel. Each time an image passes through a convolutional layer, the output also is considered a channel. A convolutional layer with multiple filters that go over an image will therefore have multiple output channels (determined by the number of filters) resulting from that image, wherein the multiple channels represent different features that have been extracted.

Intra-sparsity analysis according to the present invention is performed for the input channels and output channels by defining certain metrics. A first metric is the percentage of zeroes which measures the fraction of weights and/or activations in a channel that are exactly zero. A second metric is small weight percentage, which measures the fraction of weights that are below a certain threshold, i.e. near-zero values. A final metric is L1 norm, which is the sum of absolute values of weights in a channel. Smaller L1 norms indicate less influential channels.

As detailed above, these metrics are collected using forward and backward propagation. Weights for each channel are extracted, and activations for each channel are monitored after the forward pass for several batches. The collected data is then visualized using histograms etc. so that the distribution of sparsity levels across channels can be seen. The L1 norms can be plotted in order to see which channels carry more weight.

The method then sets a level indicating how much information can be lost for each layer, and also if entire layers can be lost. Reducing the information will result in a smaller (compressed) network wherein less computation is required and can therefore be executed on a portable device, but if the network is compressed too much, the resultant network will be inefficient/unable to perform complicated calculations.

Therefore, by analyzing sparsity of the pre-trained DNN model, redundancies within parameters and feature maps can be exploited using other compression methods.

Step 304: Use a low-rank approximation method to represent the network according to the analysis results, and prune and quantize a network redundancy of the DNN model represented by the low-rank approximation according to the analysis results.

This step involves first using a low-rank approximation (LRA) method using the weight metrics obtained from the above sparsity analysis. LRA comprises approximating these metrics with low-rank counterparts. As mentioned above, the pre-trained DNN model comprises a plurality of neurons, each neuron corresponding to multiple parameters, e.g. the weight w and the bias b. Among these parameters, some are redundant and do not contribute a lot to the output. If the neurons could be ranked in the network according to the contribution, the low ranking neurons from the network could be removed to generate a smaller and faster network, i.e. the reconfigured model. For example, the ranking can be done according to the L1/L2 mean of neuron weights, the mean activations, or the number of times of not being zero on some validation set, etc.

Therefore, performing LRA can considerably reduce the model size without removing any channels or layers by reducing the effective number of parameters in the network. This representation means that an amount of computation required for both forward and backward passes of a reconfigured model is reduced. In addition, the internal representations of the network are simplified. Moreover, the simplified weight matrices may have more consistent value distributions. This is an advantage when performing subsequent pruning and quantization.

As detailed above, pruning requires removing unnecessary weights or channels to further compress the network. While pruning compresses models by reducing the number of weights, quantization consists in decreasing the size of the weights that are there. Quantization maps values from a large set to values in a smaller set, such that the output will consist of a smaller range of possible values than the input. The simplified network and weight matrices achieved by performing LRA will make it easier to identify and remove any weights or channels which do not contribute a lot to the network. Further, as the LRA has already simplified the network, pruning of this simplified network will result in an even more compact representation of the model than if pruning alone were performed, which will provide computational benefits when operating the compressed network. Moreover, the consistent value distributions achieved by LRA means that fewer quantization levels are required to represent the weights accurately. Finally, the LRA can remove small singular values that might result in noise in the network, such that a more robust network is achieved.

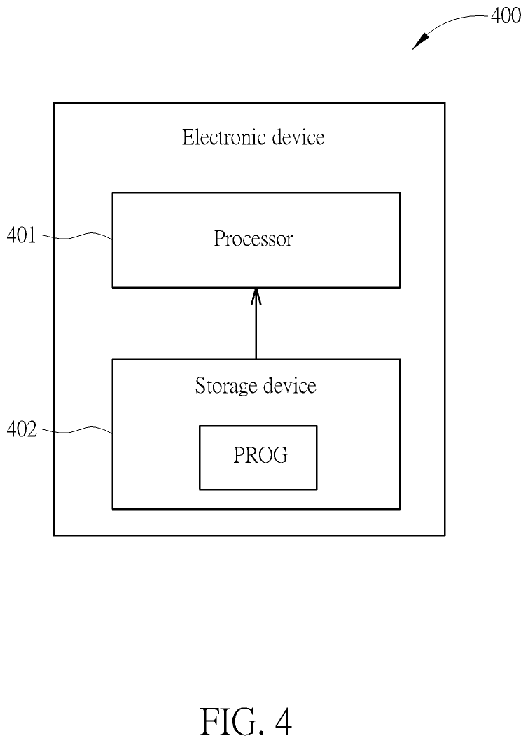

FIG. 4 is a diagram illustrating an electronic device 40 according to an embodiment of the present invention. As shown in FIG. 4, the electronic device 400 comprises a processor 401 and a storage device 402, wherein the storage device 402 stores a program code PROG. The storage device 402 may be a volatile memory or a non-volatile memory. The flow described in the implementation of FIG. 2 and FIG. 3 will be executed if the program code PROG stored in the storage device 402 is loaded and executed by the processor 401. The person skilled in the art should understand the implementation readily after reading the above paragraphs; a detailed description is thus omitted here for brevity.

After the pre-trained DNN model is compressed by the proposed methodology, the reconfigured model is applicable for the end-user application and executed on the end-user terminal. The end-user application, in this embodiment, can be used for image recognition or speech recognition, although this is not a limitation of the present invention. As sufficient statistical analysis on inter and intra layers has been performed, as well as the use of the low-rank approximation technique to obtain a correct statistical analysis in preparation for pruning and quantization, the amount of sparsity which will not impact on the network performance can be clearly known. Therefore, compression with good performance can be guaranteed and no re-training or fine-tuning is required.

Through the above compression operation, the pre-trained model with a large scale is compressed into the reconfigured model which is applicable for the end-user application.

Briefly summarized, by compressing the pre-trained DNN model with a large scale to remove its redundancy, a reconfigured model with a customized model size and having an acceptable computational complexity is generated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A self-tuning model compression methodology for reconfiguring a Deep Neural Network (DNN), comprising:
receiving a pre-trained DNN model and a data set, wherein the pre-trained DNN model comprises an input layer, at least one hidden layer and an output layer, and said at least one hidden layer and the output layer of the pre-trained DNN model comprise a plurality of neurons;
performing an inter-layer sparsity analysis of the pre-trained DNN model to generate a first sparsity result;
performing an intra-layer sparsity analysis of the pre-trained DNN model to generate a second sparsity result, comprising:
defining a plurality of sparsity metrics for the network;
performing forward and backward passes to collect data corresponding to the sparsity metrics;
using the collected data to calculate values for the defined sparsity metrics; and
visualizing the calculated values using at least a histogram;
according to the first and second sparsity results, performing low-rank approximation on the pre-trained DNN to represent the pre-trained DNN model with low-rank counterparts;
pruning the represented DNN model according to the first and second sparsity results;
performing quantization on the pruned DNN model according to the first and second sparsity results to generate a reconfigured model of the DNN; and
executing the reconfigured model on a user terminal for an end-user application.

2. The self-tuning methodology of claim 1, wherein the defined sparsity metrics comprise percentage of zeroes, small weight percentage, and L1 norms.

3. The self-tuning methodology of claim 2, wherein the collected data comprises weight data obtained by extracting weights for all channels in the pre-trained DNN model, and activation data obtained by monitoring activations for each channel in the pre-trained DNN model after performing a forward pass.

4. The self-tuning methodology of claim 3, wherein the weight data is used to calculate the percentage of zeroes and the percentage of small weights, and the activation data is used to calculate an average activation value or a percentage of activations below a certain threshold to compute an L1 norm for each channel.

5. The self-tuning methodology of claim 1, wherein the DNN model is used for computer vision targeted application models including an AlexNet, a VGG16, a ResNet, and a MobileNet, and natural language understanding application models.

6. The self-tuning methodology of claim 1, wherein each of said at least one hidden layer and the output layer of the reconfigured model is a convolutional layer or a fully-connected layer.

7. The self-tuning methodology of claim 1, wherein the end-user application is a visual recognition application or a speech recognition application.

8. The self-tuning methodology of claim 1, wherein a number of the plurality of neurons of the reconfigured model is less than a number of the plurality of neurons of the DNN model.

9. An electronic device, comprising:
a storage device, arranged to store a program code; and
a processor, arranged to execute the program code;
wherein when loaded and executed by the processor, the program code instructs the processor to execute the following steps:
receiving a pre-trained DNN model and a data set, wherein the pre-trained DNN comprises an input layer, at least one hidden layer and an output layer, and said at least one hidden layer and the output layer of the pre-trained DNN model comprise a plurality of neurons;
performing an inter-layer sparsity analysis of the pre-trained DNN model to generate a first sparsity result;
performing an intra-layer sparsity analysis of the pre-trained DNN model to generate a second sparsity result, comprising:
defining a plurality of sparsity metrics for the network;
performing forward and backward passes to collect data corresponding to the sparsity metrics;
using the collected data to calculate values for the defined sparsity metrics; and
visualizing the calculated values using at least a histogram;
according to the first and second sparsity results, performing low-rank approximation on the pre-trained DNN to represent the pre-trained DNN model with low-rank counterparts;
pruning the represented DNN model according to the first and second sparsity results; and
performing quantization on the pruned DNN model according to the first and second sparsity results;
wherein the reconfigured model is executed on a user terminal of the electronic device for an end-user application.

10. The electronic device of claim 9, wherein the defined sparsity metrics comprise percentage of zeroes, small weight percentage, and L1 norms.

11. The electronic device of claim 10, wherein the collected data comprises weight data obtained by extracting weights for all channels in the pre-trained DNN model, and activation data obtained by monitoring activations for each channel in the pre-trained DNN model after performing a forward pass.

12. The electronic device of claim 11, wherein the weight data is used to calculate the percentage of zeroes and the percentage of small weights, and the activation data is used to calculate an average activation value or a percentage of activations below a certain threshold to compute an L1 norm for each channel.

13. The electronic device of claim 9, wherein a number of the plurality of neurons of the reconfigured model is less than a number of the plurality of neurons of the DNN model.

14. The electronic device of claim 9, wherein each of the plurality of neurons of the reconfigured model corresponds to at least one of a multiplexer and an adder, each of the plurality of neurons of the DNN model corresponds to at least one of a multiplexer and an adder, and the DNN model is compressed by removing a portion of the multiplexers and adders in the DNN model according to the analysis result so that a number of multiplexers and adders in the reconfigured model is less than a number of multiplexers and adders in the DNN model.

15. The electronic device of claim 9, wherein the DNN model is used for computer vision targeted application models including an AlexNet, a VGG16, a ResNet, and a MobileNet, and natural language understanding application models.

16. The electronic device of claim 9, wherein each of said at least one hidden layer and the output layer of the reconfigured model is a convolutional layer or a fully-connected layer.

17. The electronic device of claim 9, wherein the end-user application is a visual recognition application, a speech recognition application, or a natural language understanding application.
